(19) United States
(12) Patent Application Publication
(10) Pub. No.: US 2026/0118980 A1
(43) Pub. Date: Apr. 30, 2026

(54) MOUSE SCROLL WHEEL MODULE

(71) Applicant: Primax Electronics Ltd., Taipei (TW)

(72) Inventors: Ya-Jun Li, Taipei (TW); Qing-Lin Zeng, Taipei (TW); Chun-Cheng Lu, Taipei (TW)

(21) Appl. No.: 18/962,157

(22) Filed: Nov. 27, 2024

(30) Foreign Application Priority Data
Oct. 30, 2024 (CN) 202411535898.2

(51) Int. Cl. G06F 3/0362

(52) U.S. Cl. CPC G06F 3/0362

(57) ABSTRACT

A mouse scroll wheel module includes a scroll wheel, an encoder disc and a soft connection structure. The scroll wheel includes a wheel body and a rotating shaft. The rotating shaft is located at an axis center of the wheel body. A polygonal rod is formed on a first end of the rotating shaft. The encoder disc includes a first shaft tube. The first shaft tube has a shaft hole. The soft connection structure is disposed within the axis hole of the encoder disc. The soft connection structure includes a connecting segment. An inner surface of the connecting segment has a plurality of connecting surfaces corresponding to the polygonal rod. When the polygonal rod is inserted into the shaft hole, the polygonal rod is closely attached on the plurality of connecting surfaces. Consequently, the scroll wheel and the encoder disc are combined together.

### FIELD OF THE INVENTION

The present invention relates to a mechanism of an input device, and more particularly to a mouse scroll wheel module for a mouse device.

### BACKGROUND OF THE INVENTION

A mouse is used to control a cursor on a display screen of a computer in order to operate the computer. Since 1968, the United States has produced the world’s first mouse. After then, the mouse is applied to word processing operations, video games, industrial drawings, drawing design or media production. Consequently, the mouse has become an indispensable part of the computer system.

Generally, the operation interface of a mouse includes a left button, a right button and a scroll wheel. In order to improve the convenience of operating the mouse scroll wheel, a micro switch is usually located under the scroll wheel and used as a middle button.

FIG. 1 is a schematic cross-sectional view illustrating the structure of a conventional mouse scroll wheel module. As shown in FIG. 1, the mouse scroll wheel module 90 includes a scroll wheel 91, a micro switch 92, an encoder disc 93, a signal output housing 94 and an elastic sheet 95.

The scroll wheel 91 includes a wheel body 911 and a rotating shaft 912. The rotating shaft 912 is located at the axis center of the wheel body 911. A first end of the rotating shaft 912 has a polygonal rod 9121. A second end of the rotating shaft 912 opposed to the polygonal rod 9121 is located over the micro switch 92 to push the micro switch 92. The signal output housing 94 installed on a circuit board B. The signal output housing 94 includes a first covering member 941 and a second covering member 942, which are combined together. The encoder disc 93 and the elastic sheet 95 are accommodated within the signal output housing 94. Furthermore, the polygonal rod 9121 of the scroll wheel 91 is inserted into a shaft hole 931 of the encoder disc 93. Since the polygonal rod 9121 of the scroll wheel 91 is connected and linked with the encoder disc 93, the encoder disc 93 is rotated with the scroll wheel 91, and an input signal is correspondingly generated.

FIG. 2A and FIG. 2B are schematic cross-sectional views illustrating the connection between the encoder disc and the polygonal rod of the scroll wheel in the conventional mouse scroll wheel module. Generally, the scroll wheel 91 and the encoder disc 93 are made of hard plastic material, e.g., polyethylene (PE), polypropylene (PP) or polyethylene terephthalate (PET). As known, the component made of hard plastic material may result in tolerance during the manufacturing process. For example, if the inner diameter of the shaft hole 931 is larger, there is a gap g between the inner wall surface of the shaft hole 931 and the polygonal rod 9121 (see FIG. 2A). As the encoder disc 93 is rotated with the scroll wheel 91, the gap g will cause the polygonal rod 9121 to vibrate and generate noise. Whereas, if the inner diameter of the shaft hole 931 is smaller due to tolerance, the inner wall surface of the shaft hole 931 will squeeze the polygonal rod 9121 (see FIG. 2B). Consequently, an interference fit condition occurs. When the scroll wheel 91 is pressed, an unsatisfactory pressing feel is provided to the user.

In order to overcome the drawbacks of the conventional technologies, it is important to provide a mouse scroll wheel module that generates reduced vibration noise and satisfied pressing feel.

### SUMMARY OF THE INVENTION

The present invention provides a mouse scroll wheel module that generates reduced vibration noise and satisfied pressing feel.

In accordance with an aspect of the present invention, a mouse scroll wheel module is provided. The mouse scroll wheel module includes a scroll wheel, an encoder disc and a soft connection structure. The scroll wheel includes a wheel body and a rotating shaft. The rotating shaft is located at an axis center of the wheel body. A polygonal rod is formed on a first end of the rotating shaft. The encoder disc includes a first shaft tube. The first shaft tube has a shaft hole. The soft connection structure is disposed within the axis hole of the encoder disc. The soft connection structure includes a connecting segment. An inner surface of the connecting segment has a plurality of connecting surfaces corresponding to the polygonal rod. When the polygonal rod is inserted into the shaft hole, the polygonal rod is closely attached on the plurality of connecting surfaces. Consequently, the scroll wheel and the encoder disc are combined together.

In an embodiment, the soft connection structure further includes a guiding segment. The guiding segment is connected with the connecting segment. The guiding segment is arranged between the connecting segment and an opening side of the shaft hole.

In an embodiment, an inner diameter of the guiding segment gradually increases in a direction from the connecting segment to the opening side of the shaft hole. An inner surface of the guiding segment has a plurality of first guiding surfaces, which are connected with each other and correspond to the polygonal rod. When the polygonal rod of the rotating shaft is inserted into the shaft hole, the polygonal rod is guided into the connecting segment through the first guiding surfaces.

In an embodiment, the guiding segment of the soft connection structure is formed as the first shaft tube.

In an embodiment, a first tube structure is protruded from a side of the encoder disc facing the scroll wheel, and the first tube structure is formed as the first shaft tube.

In an embodiment, a plurality of position-limiting recesses are discretely formed in an end surface of the first tube structure, and a plurality of position-limiting bulges corresponding to the plurality of position-limiting recesses are formed on an outer surface of the guiding segment at the opening side of the shaft hole. The position-limiting bulges are respectively engaged with the corresponding position-limiting recesses.

In an embodiment, a plurality of connecting bulges are formed on the plurality of connecting surfaces of the connecting segment, and the connecting bulges are pressed against the corresponding rod surfaces of the polygonal rod.

In an embodiment, a first tube structure is protruded from a side of the encoder disc facing the scroll wheel, and the first tube structure is formed as the first shaft tube. An inner wall of the first tube structure has a plurality of second guiding surfaces, which are connected with each other and correspond to the polygonal rod. When the polygonal rod is inserted into the shaft hole, the polygonal rod is guided into the connecting segment through the second guiding surfaces.

In an embodiment, a second tube structure is protruded from a side of the encoder disc opposed to the first shaft tube.

In an embodiment, the soft connection structure further includes a coupling segment, and the coupling segment is connected with the connecting segment. The coupling segment is extended from the connecting segment in a direction away from an opening side of the shaft hole. The coupling segment is coupled with the second tube structure. The coupling segment and the second tube structure are collaboratively formed as a second shaft tube.

From the above descriptions, the present invention provides the mouse scroll wheel module. The encoder disc is connected with the scroll wheel through the soft connection structure within the encoder disc. Since the soft connection structure has the elastically compressible property, the polygonal rod of the scroll wheel and the shaft hole of the encoder disc can be tightly coupled to each other. Due to this structural design, there is no gap between the polygonal rod and the shaft hole. Consequently, when the encoder disc is rotated with the scroll wheel, the noise generated by the vibration can be effectively reduced. Furthermore, the interference fit between the polygonal rod and the shaft hole can be effectively reduced. When the scroll wheel is pressed, the satisfactory pressing feel can be provided.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic cross-sectional view illustrating the structure of a conventional mouse scroll wheel module;

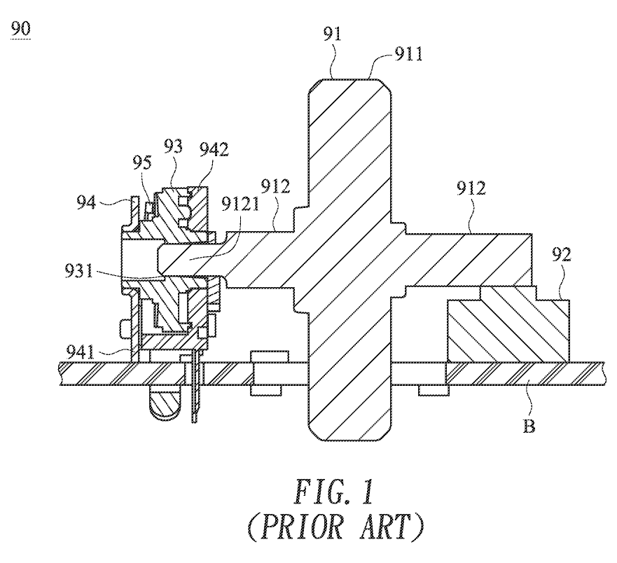

FIG. 2A and FIG. 2B are schematic cross-sectional views illustrating the connection between the encoder disc and the polygonal rod of the scroll wheel in the conventional mouse scroll wheel module;

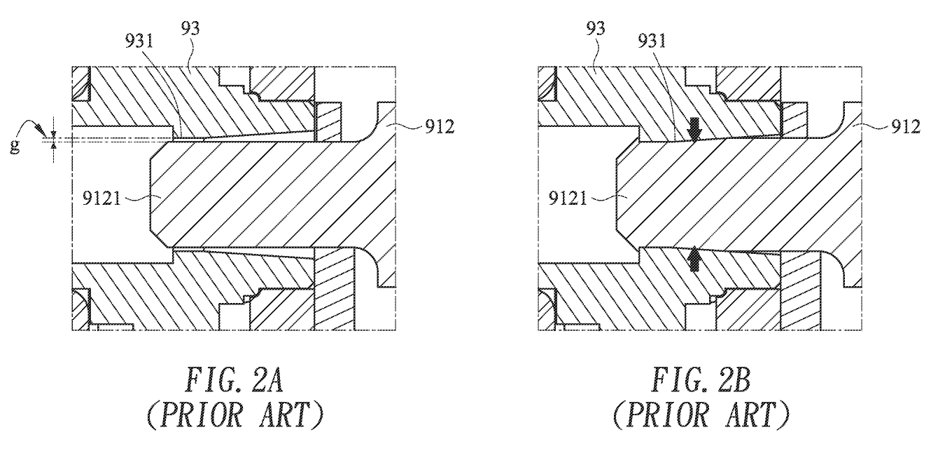

FIG. 3A is a schematic perspective view illustrating the structure of a mouse scroll wheel module according to an embodiment of the present invention;

FIG. 3B is a schematic exploded view illustrating the structure of the mouse scroll wheel module according to the embodiment of the present invention;

FIG. 4 is a schematic cutaway view illustrating a first exemplary encoder disc used in the mouse scroll wheel module of the present invention;

FIG. 5 is a schematic cross-sectional view illustrating the connection between the encoder disc and the polygonal rod of the scroll wheel in the mouse scroll wheel module of the present invention;

FIG. 6 is a schematic cutaway view illustrating a second exemplary encoder disc used in the mouse scroll wheel module of the present invention;

FIG. 7 is a schematic cutaway view illustrating a third exemplary encoder disc used in the mouse scroll wheel module of the present invention; and

FIG. 8 is a schematic cutaway view illustrating a fourth exemplary encoder disc used in the mouse scroll wheel module of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

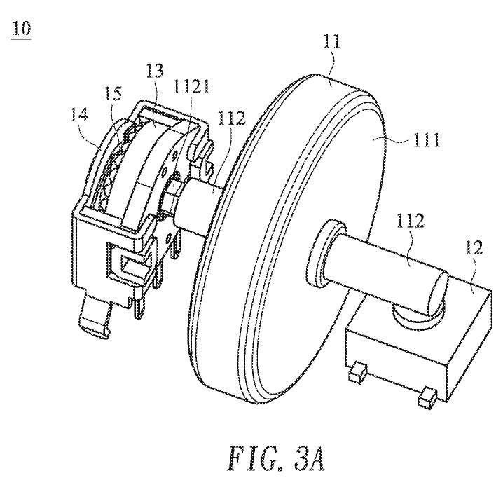

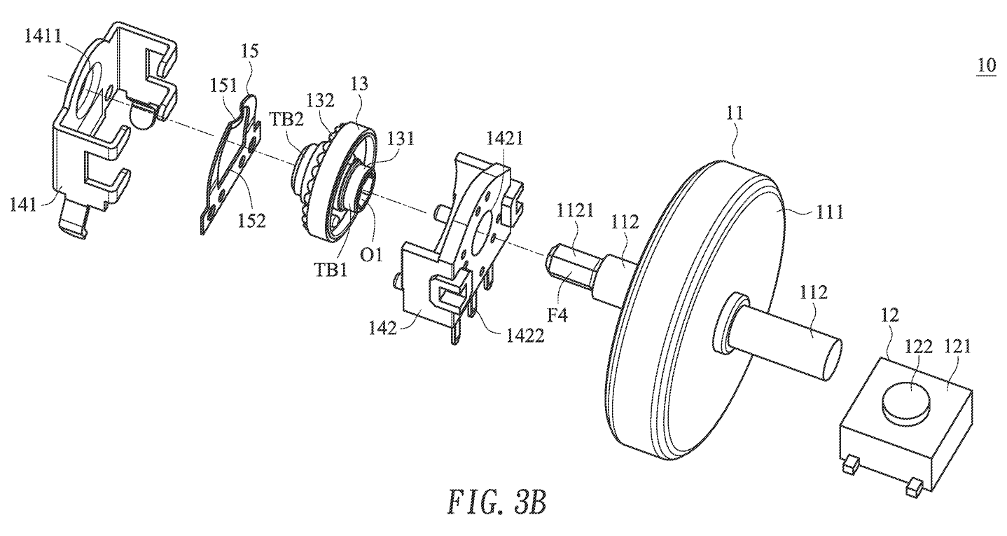

Please refer to FIGS. 3A and 3B. FIG. 3A is a schematic perspective view illustrating the structure of a mouse scroll wheel module according to an embodiment of the present invention. FIG. 3B is a schematic exploded view illustrating the structure of the mouse scroll wheel module according to the embodiment of the present invention. In an embodiment, the mouse scroll wheel module 10 includes a scroll wheel 11, a micro switch 12, an encoder disc 13, a signal output housing 14 and an elastic sheet 15.

The scroll wheel 11 includes a wheel body 111 and a rotating shaft 112. The rotating shaft 112 is located at the axis center of the wheel body 111. A first end of the rotating shaft 112 has a polygonal rod 1121. The micro switch 12 includes a switch body 121 and a pressing part 122. The pressing part 122 is disposed on the switch body 121. A second end of the rotating shaft 112 opposed to the polygonal rod 1121 is located over the micro switch 12 and contacted with the pressing part 122 of the micro switch 12. Furthermore, the polygonal rod 1121 of the rotating shaft 112 has a plurality of rod surfaces F4.

The encoder disc 13 and the elastic sheet 15 are accommodated within the signal output housing 14. The encoder disc 13 includes a first shaft tube TB1 and a second shaft tube TB2. The first shaft tube TB1 and the second shaft tube TB2 are coaxially arranged on two opposite side surfaces of the encoder disc 13, respectively. The first shaft tube TB1 has a shaft hole O1. The side surface of the encoder disc 13 on the same side as the second shaft tube TB2 is provided with a plurality of contiguous groove structures 132. The elastic sheet 15 includes an elastic arm 151 and an avoidance opening 152. The signal output housing 14 includes a first covering member 141 and a second covering member 142, which are combined together. An avoidance recess 1411 is formed in the inner surface of the first covering member 141 and aligned with the second shaft tube TB2. The second covering member 142 includes a perforation 1421. In addition, a plurality of pins 1422 are installed on a bottom surface of the second covering member 142. The first shaft tube TB1 is aligned with the perforation 1421.

The first shaft tube TB1 is penetrated through the perforation 1421. In addition, the second shaft tube TB2 is penetrated through the avoidance opening 152 of the elastic sheet 15 and inserted into the avoidance recess 1411. Consequently, the encoder disc 13, the elastic sheet 15 and the signal output housing 14 are combined together. Under this circumstance, the encoder disc 13 is rotatable relative to the signal output housing 14, and the elastic arm 151 of the elastic sheet 15 is contacted with the groove structures 132 of the encoder disc 13. After the assembling process is completed, the combination of the encoder disc 13, the elastic sheet 15 and the signal output housing 14 is installed on a circuit board (not shown) through the plurality of pins 1422 on the bottom surface of the signal output housing 14.

Furthermore, the polygonal rod 1121 of the rotating shaft 112 of the scroll wheel 11 is inserted into and combined with the shaft hole O1. Consequently, the scroll wheel 11 is connected with the encoder disc 13, and the encoder disc 13 is synchronously rotated with the scroll wheel 11. While the encoder disc 13 is rotated with the scroll wheel 11, the elastic arm 151 of the elastic sheet 15 is continuously contacted with the concave and convex structures of the groove structures 132 of the encoder disc 13 in an alternate manner. Consequently, the rotation of the scroll wheel 11 provides a stepped rotation feel.

Furthermore, the inner surface of the second covering member 142 facing the encoder disc 13 and the side surface of the encoder disc 13 facing the second covering member 142 are provided with metal sensing circuits (not shown) that are contacted with each other. Consequently, when the encoder disc 13 is rotated relative to the signal output housing 14, the metal sensing circuits can sense the rotation direction and rotation speed of the encoder disc 13 and generate the corresponding input signal. Then, the input signal is transmitted to the circuit board (not shown) through the pins 1422.

Some examples of the encoder disc will be described as follows.

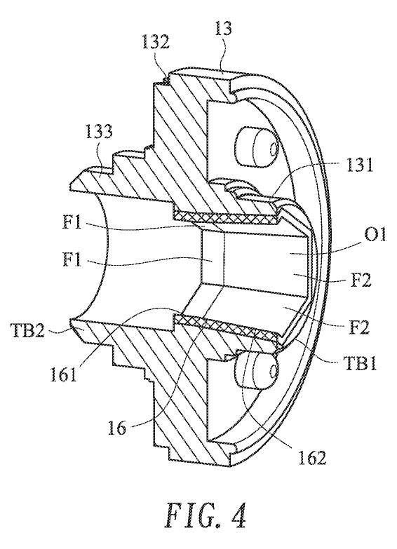

FIG. 4 is a schematic cutaway view illustrating a first exemplary encoder disc used in the mouse scroll wheel module of the present invention. As shown in FIG. 4, a first tube structure 131 is protruded from the side of the encoder disc 13 facing the scroll wheel 11. The first tube structure 131 is formed as the first shaft tube TB1 and the shaft hole O1. A second tube structure 133 coaxial with the first tube structure 131 is protruded from the side of the encoder disc 13 opposed to the first shaft tube TB1. The second tube structure 133 is formed as the second shaft tube TB2.

Furthermore, a soft connection structure 16 is disposed within the axis hole O1 of the encoder disc 13. The soft connection structure 16 is formed in the encoder disc 13 by a double injection molding process. The material of the soft connection structure 16 is liquid silicone (LSR), silicone, thermoplastic polyurethane (TPU) or thermoplastic elastomer (TPE). The thickness of the soft connection structure 16 is between 0.1 mm and 0.3 mm.

In an embodiment, the soft connection structure 16 includes a connecting segment 161 and a guiding segment 162 connected to the connecting segment 161. The guiding segment 162 is arranged between the connecting segment 161 and the opening side of the shaft hole O1. The inner diameter of the guiding segment 162 gradually increases in the direction from the connecting segment 161 to the opening side of the shaft hole O1. In addition, the end part of the guiding segment 162 is flush with the end part of the first tube structure 131.

The inner surface of the connecting segment 161 has a plurality of connecting surfaces F1. The inner surface of the guiding segment 162 has a plurality of first guiding surfaces F2, which are connected with each other. The connecting surfaces F1 and the first guiding surfaces F2 correspond to the rod surfaces F4 of the polygonal rod 1121.

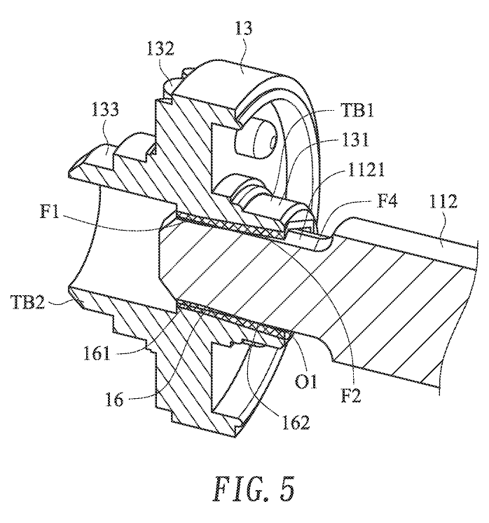

FIG. 5 is a schematic cross-sectional view illustrating the connection between the encoder disc and the polygonal rod of the scroll wheel in the mouse scroll wheel module of the present invention. When the polygonal rod 1121 of the rotating shaft 112 is inserted into the shaft hole O1, the polygonal rod 1121 can be guided into the connecting segment 161 through the first guiding surfaces F2 of the guiding segment 162. Consequently, the scroll wheel 11 and the encoder disc 13 are combined together. Since the soft connection structure 16 has the elastically compressible property, the connecting surfaces F1 and the rod surfaces F4 of the polygonal rod 1121 can be closely attached on each other. Due to this structural design, there is no gap between the shaft hole O1 of the first tube structure 131 and the polygonal rod 1121 of the rotating shaft 112. Consequently, when the encoder disc 13 is rotated with the scroll wheel 11, the noise generated by the vibration can be effectively reduced. Furthermore, since the soft connection structure 16 has the elastically compressible property, the interference fit between the shaft hole O1 and the polygonal rod 1121 can be effectively reduced. When the scroll wheel 11 is pressed, the satisfactory pressing feel can be provided.

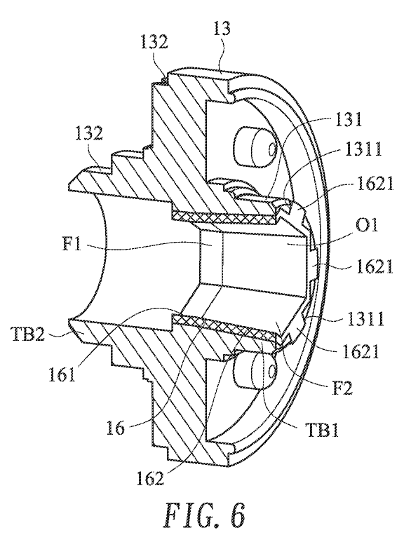

FIG. 6 is a schematic cutaway view illustrating a second exemplary encoder disc used in the mouse scroll wheel module of the present invention. The functions and operations of the encoder disc 13 and the soft connection structure 16 of this embodiment are similar to those of FIG. 5, and the identical aspects will not be redundantly described herein. In comparison with FIG. 5, the structure of the first tube structure 131 and the structure of the guiding segment 162 in this embodiment are distinguished. As shown in FIG. 6, a plurality of position-limiting recesses 1311 are discretely formed in an end surface of the first tube structure 131, and a plurality of position-limiting bulges 1621 corresponding to the plurality of position-limiting recesses 1311 are formed on an outer surface of the guiding segment 162 at the opening side of the shaft hole O1. The position-limiting bulges 1621 are respectively engaged with the corresponding position-limiting recesses 1311. Due to this structural design, the soft connection structure 16 will not be slid relative to the encoder disc 13.

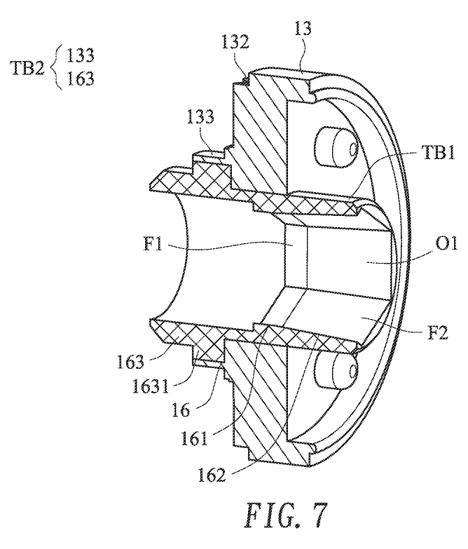

FIG. 7 is a schematic cutaway view illustrating a third exemplary encoder disc used in the mouse scroll wheel module of the present invention. The functions and operations of the encoder disc 13 and the soft connection structure 16 of this embodiment are similar to those of FIG. 5, and the identical aspects will not be redundantly described herein. In comparison with FIG. 5, the soft connection structure 16 of this embodiment further includes a coupling segment 163. The coupling segment 163 is connected with the connecting segment 161. The coupling segment 163 is extended from the connecting segment 161 in the direction away from the opening side of the shaft hole O1. In addition, the coupling segment 163 is coupled with the inner wall of the second tube structure 133. Consequently, the coupling segment 163 and the second tube structure 133 are collaboratively formed as the second shaft tube TB2. In this embodiment, a coupling bulge 1631 is circumferentially formed on an outer surface of the coupling segment 163. The coupling bulge 1631 is coupled with the inner wall of the second tube structure 133. In this embodiment, the side of the encoder disc 13 facing the scroll wheel 11 is not provided with the first tube structure 131. In contrast, the guiding segment 162 of the soft connection structure 16 is protruded from the side of the encoder disc 13 facing the scroll wheel 11 and served as the first shaft tube TB1. Preferably, the thickness of the guiding segment 162 is at least greater than 0.3 mm.

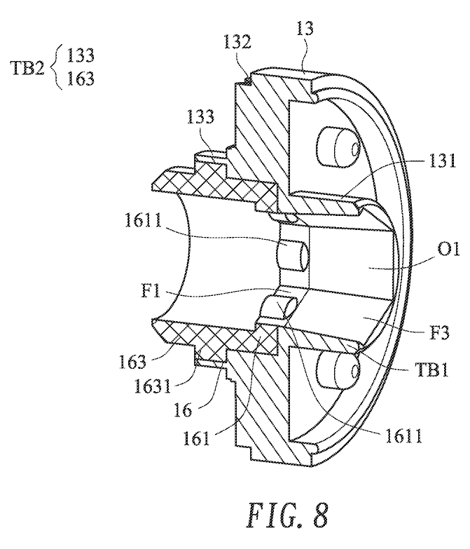

FIG. 8 is a schematic cutaway view illustrating a fourth exemplary encoder disc used in the mouse scroll wheel module of the present invention. The functions and operations of the encoder disc 13 and the soft connection structure 16 of this embodiment are similar to those of FIG. 7, and the identical aspects will not be redundantly described herein. In comparison with FIG. 7, the soft connection structure 16 of this embodiment is not equipped with the guiding segment 162. Especially, the inner wall of the first tube structure 131 protruded from the encoder disc 13 has a plurality of second guiding surfaces F3, which are connected with each other. Similarly, the second guiding surfaces F3 correspond to the rod surfaces F4 of the polygonal rod 1121. When the polygonal rod 1121 of the rotating shaft 112 is inserted into the shaft hole O1, the polygonal rod 1121 can be guided into the connecting segment 161 through the second guiding surfaces F3 of the first tube structure 131. Consequently, the scroll wheel 11 and the encoder disc 13 are combined together. Furthermore, a plurality of connecting bulges 1611 are formed on the connecting surfaces F1 of the connecting segment 161 of the soft connection structure 16.

When the polygonal rod 1121 is introduced into the connecting segment 161, the connecting bulges 1611 are pressed against the corresponding rod surfaces F4 of the polygonal rod 1121. Since the contact area between the connecting bulge 1611 and the corresponding rod surface F4 is smaller, the connection between the connecting segment 161 and the polygonal rod 1121 is effectively enhanced.

From the above descriptions, the present invention provides the mouse scroll wheel module. The encoder disc is connected with the scroll wheel through the soft connection structure within the encoder disc. Since the soft connection structure has the elastically compressible property, the polygonal rod of the scroll wheel and the shaft hole of the encoder disc can be tightly coupled to each other. Due to this structural design, there is no gap between the polygonal rod and the shaft hole. Consequently, when the encoder disc is rotated with the scroll wheel, the noise generated by the vibration can be effectively reduced. Furthermore, the interference fit between the polygonal rod and the shaft hole can be effectively reduced. When the scroll wheel is pressed, the satisfactory pressing feel can be provided. In other words, the technologies of the present invention are industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A mouse scroll wheel module, comprising:
a scroll wheel comprising a wheel body and a rotating shaft, wherein the rotating shaft is located at an axis center of the wheel body, and a polygonal rod is formed on a first end of the rotating shaft;
an encoder disc comprising a first shaft tube, wherein the first shaft tube has a shaft hole; and
a soft connection structure disposed within the axis hole of the encoder disc, and comprising a connecting segment, wherein an inner surface of the connecting segment has a plurality of connecting surfaces corresponding to the polygonal rod,
wherein when the polygonal rod is inserted into the shaft hole, the polygonal rod is closely attached on the plurality of connecting surfaces, so that the scroll wheel and the encoder disc are combined together.

2. The mouse scroll wheel module according to claim 1, wherein the soft connection structure further comprises a guiding segment, wherein the guiding segment is connected with the connecting segment, and the guiding segment is arranged between the connecting segment and an opening side of the shaft hole.

3. The mouse scroll wheel module according to claim 2, wherein an inner diameter of the guiding segment gradually increases in a direction from the connecting segment to the opening side of the shaft hole, and an inner surface of the guiding segment has a plurality of first guiding surfaces, which are connected with each other and correspond to the polygonal rod, wherein when the polygonal rod of the rotating shaft is inserted into the shaft hole, the polygonal rod is guided into the connecting segment through the first guiding surfaces.

4. The mouse scroll wheel module according to claim 2, wherein the guiding segment of the soft connection structure is formed as the first shaft tube.

5. The mouse scroll wheel module according to claim 2, wherein a first tube structure is protruded from a side of the encoder disc facing the scroll wheel, and the first tube structure is formed as the first shaft tube.

6. The mouse scroll wheel module according to claim 5, wherein a plurality of position-limiting recesses are discretely formed in an end surface of the first tube structure, and a plurality of position-limiting bulges corresponding to the plurality of position-limiting recesses are formed on an outer surface of the guiding segment at the opening side of the shaft hole, wherein the position-limiting bulges are respectively engaged with the corresponding position-limiting recesses.

7. The mouse scroll wheel module according to claim 1, wherein a plurality of connecting bulges are formed on the plurality of connecting surfaces of the connecting segment, and the connecting bulges are pressed against the corresponding rod surfaces of the polygonal rod.

8. The mouse scroll wheel module according to claim 1, wherein a first tube structure is protruded from a side of the encoder disc facing the scroll wheel, and the first tube structure is formed as the first shaft tube, wherein an inner wall of the first tube structure has a plurality of second guiding surfaces, which are connected with each other and correspond to the polygonal rod, wherein when the polygonal rod is inserted into the shaft hole, the polygonal rod is guided into the connecting segment through the second guiding surfaces.

9. The mouse scroll wheel module according to claim 1, wherein a second tube structure is protruded from a side of the encoder disc opposed to the first shaft tube.

10. The mouse scroll wheel module according to claim 9, wherein the soft connection structure further comprises a coupling segment, and the coupling segment is connected with the connecting segment, wherein the coupling segment is extended from the connecting segment in a direction away from an opening side of the shaft hole, the coupling segment is coupled with the second tube structure, and the coupling segment and the second tube structure are collaboratively formed as a second shaft tube.
